(19) United States
(12) Patent Application Publication
(10) Pub. No.: US 2025/0299028 A1
(43) Pub. Date: Sep. 25, 2025

(54) ARTIFICIAL NEURAL NETWORK BASED AUDIOVISUAL MEDIA SEQUENCING

(71) Applicant: ObviousFuture GmbH, Kaiserslautern (DE)

(72) Inventor: Eduard Weinwurm, Vienna (AT)

(21) Appl. No.: 19/089,745

(22) Filed: Mar. 25, 2025

Related U.S. Application Data
(60) Provisional application No. 63/569,370, filed on Mar. 25, 2024.

(51) Int. Cl. G06N 3/0475; G06N 3/045

(52) U.S. Cl. CPC G06N 3/0475; G06N 3/045

(57) ABSTRACT

Method and apparatus for generating a digital data set such as an audio-visual (AV) work. In some embodiments, a selected digital element at a transition point is identified, and at least first and second alternative digital elements are selected as candidates to immediately follow the transition point. The candidate elements may be selected using a first artificial neural network (ANN) trained using a set of preceding digital elements. First and second alternative timelines are constructed that extend from the candidate elements. At least one user preference parameter is used to train a second ANN, which is used to select the final timeline which is thereafter incorporated into the work. The alternative digital elements may be selected from a population of existing elements based on similarity measurements, or may be AI generated using a third ANN. The system can be used for post production editing and tailored to individual user preferences.

### RELATED APPLICATIONS

The present application makes a claim of domestic priority to U.S. Provisional Patent Application No. 63/569,370 entitled ARTIFICIAL NEURAL NETWORK BASED AUDIOVISUAL MEDIA SEQUENCING and filed Mar. 25, 2024, and is related to co-pending U.S. patent application Ser. No. 18/802,747 entitled ARTIFICIAL NEURAL NETWORK BASED SEARCH ENGINE CIRCUITRY and filed Aug. 13, 2024. The contents of both of these applications are hereby incorporated by reference.

### BACKGROUND

Artificial neural networks, also sometimes referred to as machine learning (ML) systems, neural networks (nets), artificial intelligence (AI) systems, etc., are computer-based systems that attempt to mimic the operation of biological neural networks such as found in higher complexity animal brains. Neural networks can be used in a variety of applications including, but not limited to, image and speech recognition, language translation, social media filtering, medical diagnosis, gaming, trend and cyclic forecasting, chatbot systems, graphical generators, musical composition, and so on.

Neural networks have been found operable in a variety of applications, including generative AI type systems where content can be generated based on a prompt or input from an upstream user or process. Various embodiments of the present disclosure leverage the processing and creative capabilities of such systems in a novel and powerful way.

### SUMMARY

Various embodiments of the present disclosure are generally directed to systems and methods for characterizing and accessing data using an artificial neural network (ANN) system to explore and generate useful sequences, such as audiovisual (AV) works.

Without limitation, some embodiments operate to identify a selected digital element at a transition point in a given sequence. At least first and second alternative digital elements are selected as candidates to immediately follow the transition point. The candidate elements may be selected using a first artificial neural network (ANN) trained using a set of preceding digital elements leading up to the transition point, with the first ANN generating a first set of probability scores associated with different alternatives.

First and second alternative timelines are constructed that extend forward from the transition point commencing with the respective first and second alternative digital elements. At least one user preference parameter is used to train a second ANN, which outputs the select the final timeline which is thereafter incorporated into the work at the transition point. The alternative digital elements may be selected from a population of existing elements based on similarity measurements, or may be AI generated using a third ANN. The system can be used for post production editing, and can generate works that are tailored to different user preferences.

These and other features and advantages of various embodiments can be understood from a review of the following detailed description in conjunction with the accompanying drawings.

### BRIEF DESCRIPTION OF THE DRAWINGS

FIG. 1 is a functional block representation of a data processing system constructed and operated in accordance with various embodiments of the present disclosure.

FIG. 2 is a simplified timing diagram showing the selection of various content elements (in this case, audio-visual clips, AVCs) along a selected timeline by the system of FIG. 1 in accordance with some embodiments.

FIG. 3 is an artificial neural network (ANN) sequencing system incorporated into the system of FIG. 1 in accordance with some embodiments.

FIG. 4 is a process flow diagram to illustrate operation of the system of FIG. 3 in some embodiments.

FIG. 5 shows further aspects of another system similar to that of FIG. 3 in accordance with further embodiments.

FIG. 6 shows further aspects of another system similar to that of FIG. 5 in accordance with further embodiments.

FIGS. 7A through 7C depict aspects of media content that may be processed in accordance with some embodiments.

FIGS. 8A and 8B illustrate respective intervals of related media content such as in FIGS. 7A-7C in some embodiments.

FIGS. 9A and 9B illustrate different ways in which representative vectors (RVs) may be determined for intervals such as in FIGS. 7A-7C and 8A-8B in some embodiments.

FIG. 10 is a schematic representation of a selected digital element at a selected transition point to illustrate operation of some embodiments.

FIG. 11 is a schematic representation of a tree diagram similar to FIG. 10 in further embodiments.

FIG. 12 is a functional block representation of a controller circuit constructed and operated in accordance with some embodiments.

FIG. 13 is a functional block representation of respective ANNs of FIG. 12 in some embodiments.

FIG. 14 is a flow chart for an AV work generation routine in accordance with some embodiments.

### DETAILED DISCUSSION

Various embodiments of the present disclosure are generally directed to systems and methods for generating, accessing and/or using a repository (library) of digital content in the form of audiovisual (AV) digital elements to generate updates to an ongoing narrative sequence (e.g., a story).

AV media are usually arranged as a sequence of media elements that unfold over time to provide a human comprehensible narrative. For example, a feature-length movie (film) may provide a sequence of images (frames) that are shown in succession at a selected frame rate (e.g., 24 frames per second, fps; 30 fps; 48 fps, etc.). The frames, when shown in sequence at operating speed, combine to provide a succession of visually perceptible elements (e.g., clips, scenes, acts, etc.) that progress in an expected way so as to have a natural flow of causation from one element to the next. Failure to conform to the expected flow can be viewed as disruptive or discontinuous to a human (or artificial) intelligence based on a current understanding of the natural world.

A first expectation of a viewer of such a story is that the elements will progress sequentially along an expected timeline, so that earlier viewed events are expected to have occurred prior to later viewed events. This is based on the inherent understanding of time-based causality and the natural flow of time.

For example, if a main character in a story dies, it would be discontinuous to later show that same character alive as if nothing had happened, unless it is clear to the viewer that a flash-back or some other out-of-sequence insertion in the normal timeline flow has taken place. Similarly, if a character is shown to be present within a building, it would be discontinuous to subsequently show the character entering the building as the next action in the flow since the normal flow of time would require the character to first enter the building before being inside the building.

Aesthetic considerations are also an important component of a narrative sequence, and tend to also have a normally expected flow. It is common to progress from wide camera shots (viewpoints) that encompass a larger viewing area, followed by medium camera shots, followed by closeups. Unless the editor is specifically intending to cause disruption to the viewer, this normal progression from wide-to-close views is understood and expected as part of the aesthetic flow.

There are a number of other naturally occurring flows that are normally expected in a narrative sequence. A joke with the punchline told first is not funny; abrupt switches between unrelated characters or events cannot be easily followed; dialogue that does not advance the story or is inconsistent with expectations of previously revealed character traits or actions is jarring, and so on.

Accordingly, various embodiments provide mechanisms that allow creators to efficiently explore various narrative timelines while maintaining required sequential continuity for a narrative sequence. A particularly suitable environment for various embodiments relates to the creation of AV works (e.g., films, shorts, movies, etc.), and various examples described herein will primarily focus on such. However, it will be understood that the various embodiments presented herein are not so limited, but rather, can be extended to cover any number of different types of digital content (e.g., program code, presentations, planning documents, strategies, gameplans, drone flight paths, etc.).

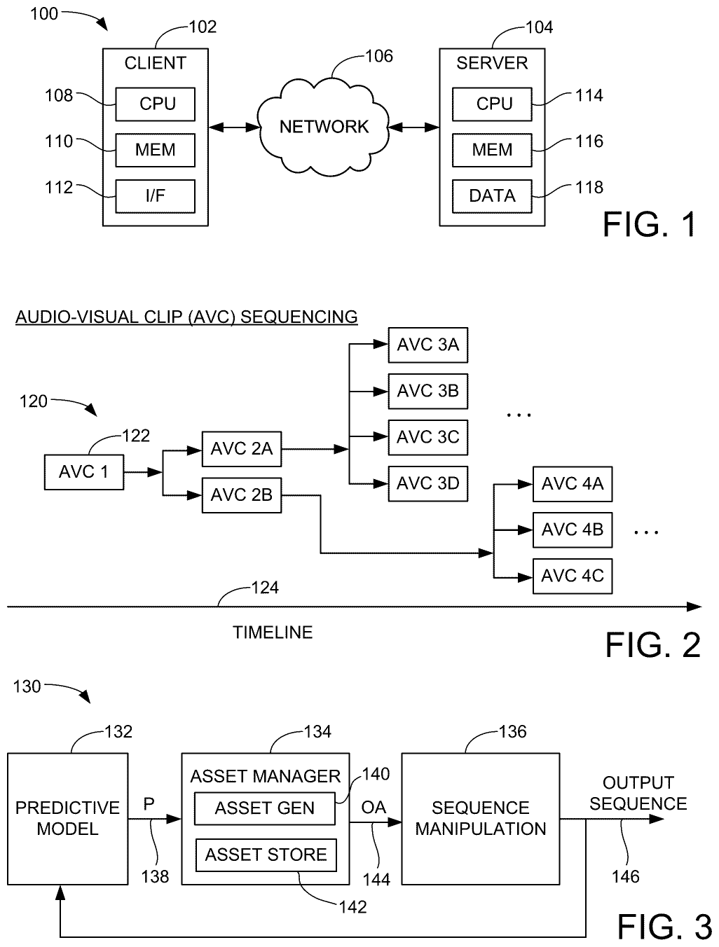

The various embodiments can be best understood beginning with a review of FIG. 1, which depicts an exemplary data processing system 100. The system 100 includes a local client (host) device 102 and a remote server 104 coupled to the client device 102 via an intervening computer network 106. Other arrangements can be used, so it will be understood that the configuration of FIG. 1 is merely illustrative and is not limiting.

The client device 102 (also sometimes referred to as a user device or an agent device) may take any number of forms such as a desktop computer, a laptop, a tablet, a smart phone, a workstation, a gaming console, a LAN, a terminal, or some other form of interactive device suitable for use by an agent in accessing the system. As used herein, the term “agent” will be understood as referring to a human or artificial (non-human) user of the system. Artificial users of the system can include AI-based systems, robots, programs, routines, or other entities that utilize the system. It will be appreciated that, as explained below, the various embodiments described herein can be incorporated into any number of different processing environments and sequences. Reference to the “user” will thus be understood as covering either or both a human or non-human agent.

The client device 102 includes a client controller (CPU) 108, memory 110 and an agent interface (I/F) 112. The controller 108 may be a programmable processor that executes software/firmware stored in the memory 110, including one or more applications (apps) or other routines. One or more hardware processors or other logic can be used in conjunction with, or in lieu of, the programmable controller 108. The agent interface 112 may include a display, pointing device, touch screen, keyboard, and/or any other elements useful in providing an agent interface for the particular agent or agents that use the system.

The server 104 is shown to similarly incorporate a server (network) controller (CPU) 114, memory 116 and data 118. The server 104 may be a gateway that in turn connects to other nodes in the network to provide the required functionality. In some cases, the operation of the system is carried out by the execution of one or more routines that are stored and executed locally at the client level, remotely at the server level, or both. The data represents a data repository or library that stores the evaluated data sets (files, objects, clips, etc.) and such storage may be local, remote, or both.

The network 106 may be a local network, a public network, a private network, a cloud or edge computing distributed network, the Internet, or some other suitable arrangement. Data centers, container storage, local and web-based applications and other techniques can be utilized as required without limitation.

The system 100 incorporates an artificial neural network (ANN) sequencing capability to provide AI-assisted or AI-generative operations during the generation of an output sequence, such as an AV media work. Elements of the ANN system can be realized at substantially any desired location or locations within the system 100 as required.

FIG. 2 shows a timing selection diagram 120 of various AV clips (AVCs) 122 that can be processed using the system of FIG. 1 in some embodiments. Each AVC 122 represents a particular clip, or element, of elapsed time with at least one of an audio content portion (e.g., sound, dialog, music, background noise, etc.) and a video content portion (e.g., some sort of visual scene made up of successive video images/frames). It will be appreciated that the sequence in FIG. 2 is merely exemplary and is not limiting.

The size and style of each AVC (clip) does not matter per se, as any number of different types of clips can be used. For purposes of the present example, each of the clips are contemplated as being of relatively short duration (e.g., 3-10 seconds, etc.) and shows one or more successive viewpoints, events and/or actions that could be displayed during a cohesive portion of the narrative along an elapsed timeline 124.

For reference, the clips are also sometimes referred to as digital elements, segments, scenes, frames, etc. In a frame based media, each clip can be from a single frame to several tens or hundreds of frames or more. In some cases, both minimum and maximum clip sizes may be specified and controllably used (e.g., at least 3 seconds and no more than 10 seconds, etc.). Longer available clips may be partitioned into multiple clips to fit within these minimum and maximum sizes. In other embodiments, all clips will be nominally the same size (duration).

While it is contemplated that the clips will be video based (e.g., have the capability of exhibiting movement over the duration thereof), in other embodiments the clips can have a nonmoving visual component in the manner similar to a story board and can represent corresponding video based elements that can be selected or generated later, so long as the informational content of the clip is adequately expressed.

The diagram 120 is essentially a tree diagram that quickly expands into numerous branches and sub-branches depending on the path taken from one clip to the next. Starting with clip AVC 1, there are multiple alternative clips that could immediately follow the AVC 1 clip, such as (but not limited to) clips AVC 2A and 2B. Each of the clips AVC 2A and AVC 2B provide separate alternative paths through respective clips AVC 3A through 3D and AVC 4A through 4C.

Further sets of alternative clips could be provided in a continuing fashion. The path through the diagram 120 that is ultimately selected uses clips that best convey and advance the desired storyline among the various alternatives (e.g., non-selected clips). The system allows the user to evaluate each of the alternatives at this point in the story in order to select the optimum path.

To give a simplified concrete example, AVC 1 may show a particular character standing on a sidewalk in a downtown urban setting. AVC 2A may show an entrance to a building, while AVC 2B may show a sidewalk. Selection of the building (e.g., the character selects to enter) passes the flow from clip AVC 2A to the alternative clips AVC 3A through AVC 3D which could be any number of different types of buildings, shots, positions, etc., such as showing the character walking into the lobby of a hotel, an office building, a library, a restaurant, etc. From there, many other options are available. For example, if a hotel is chosen, alternatives may include a view of the entire lobby, a more focused view of a concierge desk, a close up view of a fountain with the sound of bubbling water, etc. These can be further subdivided into wide, medium and close up shots of these and/or additional elements.

Similarly, if the clip AVC 2B is selected, the possible clips AVC 4A through 4C represent some other action that takes place in relation to the building. Possible alternatives include but are not limited to a view of the character looking up at the building; a viewpoint from inside an upper story window looking down at the character; the character noticing something and quickly walking away, a shot of a vehicle approaching from down the street, and so on. As before, there are myriad subsequent predictions that could be made for each of these and other available alternatives.

The particular path through the tree structure 120 that is ultimately selected (e.g., AVC 1-AVC 2A-AVC 3C . . . ) will be the path that best conveys the desired storyline (narrative) while conforming to the continuity expectations of the viewer. To this end, FIG. 3 shows an ANN sequencing system. 130 constructed and operated in accordance with some embodiments. The system 130 is incorporated into the system 100 of FIG. 1 and operates to process data elements such as the clips 122 in FIG. 2.

The system 130 includes a predictive model 132, an asset manager 134 and a sequence manipulation module 136. Other arrangements can be used, so this is merely exemplary and is not limiting. The elements 132, 134 and 136 can be realized in hardware and/or software/firmware and can be AI-based as required. The predictive model 132 selects predictions based on a selected element (e.g., the beginning clip AVC 1 in FIG. 2) and identifies a number of different, alternative predictions (P) 136 that could be reasonable next elements in the sequence.

The predictions P can be substantially anything depending on the constraints of the storyline. For example, the predictions from FIG. 2 could be the character enters the building (associated with AVC 2A) or stays outside the building (associated with AVC 2B). While only two options are shown, any number of predictions P can be output by the model 132. As discussed in greater detail below, the predictions will tend to be the most likely (e.g., have the highest probabilities) with regard to available storyline developments based on continuity and other factors.

The predictions P are supplied to the asset manager 136, which may access an asset generation module 140 and/or an asset store 142 to generate/retrieve one or more alternative elements (clips) corresponding to each of the predictions P. The asset generation module 140 can be an AI-based generation module that generates AV content corresponding to a particular prediction. The asset store 142 can be a library (e.g., computer memory) of clips which are searched to locate, retrieve and associate with the associated predictions. As noted above, multiple alternative clips can be generated or retrieved for each suitable prediction to give further alternatives to the user.

The elements (also referred to as the “output assets” or OA) obtained by the asset manager 134 are denoted at 144, and are supplied as an input to the sequence manipulation module 136. The module 136 evaluates, displays, arranges or otherwise processes the OAs 144 to generate the appropriate output sequence 146. Agent/User intervention can be supplied at any or each stage in this process as desired. Each OA can constitute a single clip or can have multiple clips for evaluation and use.

In one non-limiting example, the system could operate by starting with the selected clip (digital element) AVC 1 from FIG. 2, namely, a character standing outside in an urban environment. This represents a transition point at which alternatives will be evaluated to determine “what happens next.” The prediction model 132 can evaluate the image such as by recognizing the various elements therein, and comparing these to other parameters to arrive at some number of relevant predictions as to what the character might see or do next. Language model techniques (such as but not limited to an LLM) can be used to provide short text based descriptions of each prediction.

The asset manager 134 can in turn take each description and perform searching and/or content generation to locate relevant visual representations corresponding to each prediction. In some cases, an array of existing clips are evaluated (such as in the context of a movie editor) to identify suitable clips that correspond to a particular prediction. In other cases, the system may feed the predictions (with or without further modification) into a visual graphics AI-generation module to output suitable clips.

The sequence manipulation module 136 can thereafter assemble aspects of a tree diagram as illustrated in FIG. 2 to display the different alternatives. The clips may be played in sequence in turn for the user to illustrate the differences, or may be displayed as a storyboard type presentation to give the user a feel for each path. While one layer is contemplated at a time, multiple layers and alternatives can similarly be presented and processed. Once the user (human or automated) selects the appropriate path, the selected clip is added to the ongoing narrative sequence, and may even be fed back to the prediction module 132 for a new iteration. Each alternative path provides an alternative timeline, and ultimately a final timeline is selected.

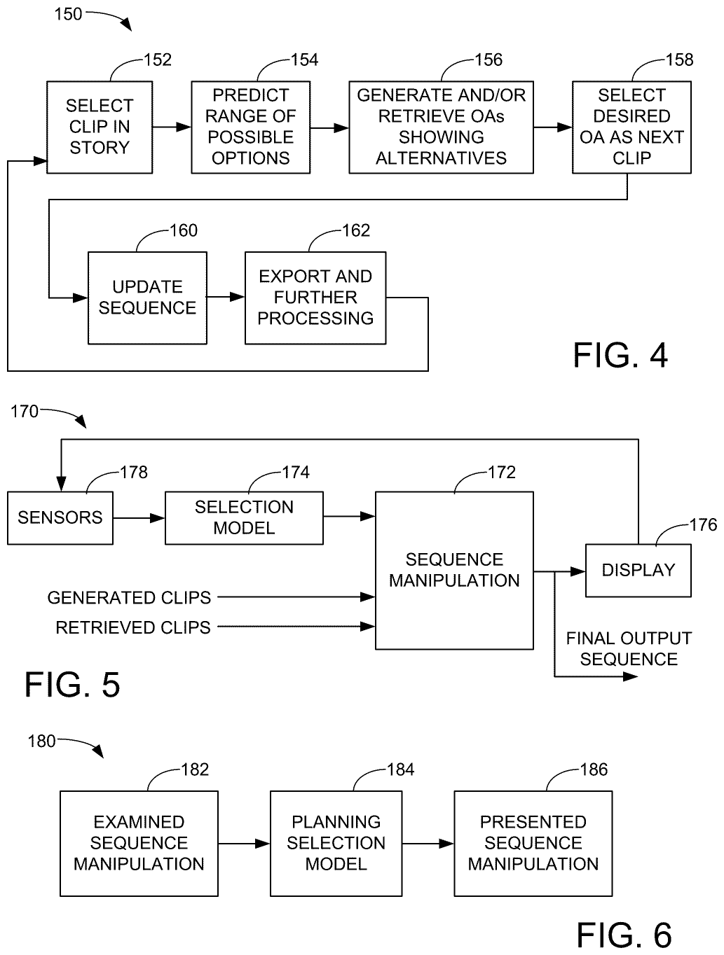

FIG. 4 shows a flow sequence 150 to describe operation of the system 130 of FIG. 3 in some embodiments. These steps include selection of the next element (clip) in the story (narrative) to be evaluated, block 152; prediction of a range of possible options for the next event in the sequence, block 154; generation and/or retrieval of appropriate OAs for the various alternatives identified by the prediction model, block 156; selection of the optimum OA as the next clip, block 158; updating of the sequence, block 160; and exporting of the updated sequence and other processing operations, block 162. As desired, the system can be recursive, such that the selected clip now becomes the next clip evaluated at block 152.

Further embodiments are generally illustrated in FIG. 5. This figure shows another ANN selecting system 170 similar to that described above in FIG. 3, including a sequence manipulation module 172 similar to the module 136. In addition, an AI-based selection module 174 provides further inputs to the selection process. These further inputs can be from a variety of feedback sources, including but not limited to a display 176 which a human observer watches.

Sensors 178 detect emotional or other types of perceptive responses of the observer, and uses that to provide further inputs to the selection model. In this way, a variety of different alternative sequences can be evaluated and an optimum path through the tree structure can be selected that best provides the desired observer response. It will be appreciated that new generated or retrieved clips can be added to the system for evaluation, as required.

In this way, the selection module 174 operates to make the ultimate choices regarding the next set of predicted assets and options. The selections can be made based on the user's current or past behavior, preferences, previous selections made to that point, and any other suitable information (including parameters such as setting, genre and other inputs). History data, rankings, publicly available and appropriate social media information and other sources can be used as required.

FIG. 6 shows another alternative ANN system 180 similar to the system 170 in FIG. 5. In this case, additional layers of analysis are provided including by an examined sequence manipulation module 182, a planning selection model 184 and a presented sequence manipulation module 186. This further allows the system to quickly evaluate and converge to an optimum sequence for the output narrative.

The embodiment of FIG. 6 enables planning and evaluating multiple alternative timelines while ensuring that the ultimate desired conclusion to the story (narrative) is reached. In some cases, the prediction module and the selecting module can be unified into an integrated single model which takes the sequence, user parameters and additional information into account. The combined model can be trained to provide, select and/or generate an optimum continuation, such as through the use of a loss function or other metrics. This would allow the system to be trained to eventually “instinctively” make correct or optimum choices on the development of the narrative.

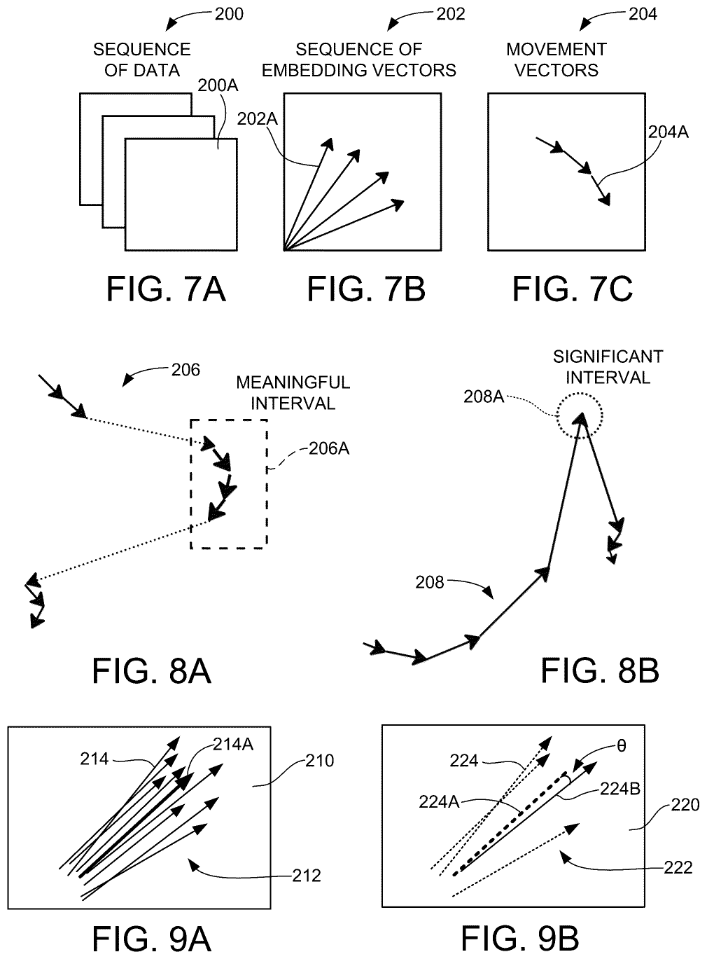

FIGS. 7A through 7C illustrate a concrete example in the form of an AV work 200 that can be processed in accordance with various embodiments. In this example, the work 200 is a full-length motion picture, although such is not limiting. As will be recognized, the motion picture 200 is made up of a sequence of data (digital) elements, e.g., frames 200A, each comprising a still image.

To provide a sense of scale, it will be assumed that the motion picture 200 is approximately 90 minutes in length and is provided with 30 frames per second (fps). This provides a total of approximately 162,000 frames to be evaluated for this one file. Other sizes and configurations can be used.

Each of these approximately 162,000 frames will have a unique ID value, such as a frame number, count, timestamp, etc. It is noted that only the video aspects of the motion picture will be processed in this example. The separate soundtrack (e.g., audio text, sounds, music, etc.) of the motion picture that accompanies the video presentation can be processed by the search engine in a follow up pass using somewhat similar techniques described below. However, it is contemplated that evaluation of both audio and video aspects of the motion picture can be performed concurrently.

In FIG. 7A, each video frame 200A in the motion picture 200, or selected frames in turn, can be sequentially forwarded to a neural net (ANN) portion of the system. The neural net portion creates a corresponding vector 202A in a corresponding latent space 202. The frames 200A are thus translated into a corresponding sequence of embedding vectors 202A that are temporarily stored by the system in a suitable memory, as generally represented in FIG. 7B.

The embedding vectors 202A are each provided with a magnitude and direction in the multi-dimensional latent space 202. Many hundreds, thousands or even more dimensions (orthogonal axes) can be defined within the space. Ultimately though, whatever the scale, each embedding vector will provide a unique distillation of the visual content of each frame as measured along each of the orthogonal dimensions within the latent space.

Because the embedding vectors 202A are associated with the sequential frames 200A, both the frames and the embedding vectors are different representations of a sequential time-sequence of digital elements. This sequence can be alternately viewed as a single moving point (or moving vector) in the latent space 202. The movement characteristics of this point in space (or angular velocity of this vector), such as the speed, direction of movement, etc., can be characterized as indicated by movement vectors 204A in FIG. 7C. A useful characterization is velocity (both speed and direction), although other characterizations can be used as well, including higher or lower order values (e.g., position, acceleration, jerk, etc.).

The velocity (movement vectors 204A) can be used to determine time intervals (also referred to as “segments”) with similar frames. One useful way to select each interval is to detect transitions where the velocity (or other movement metric) undergoes significant transitions, and to set the borders of the segment to correspond to such transition points. The borders can be identified in a number of ways, including but not limited to particular time stamps, frame counts, etc. in the original sequence 200.

A meaningful transition point is represented at 206A for a series of movement vectors 206 in FIG. 8A. As will be understood by the skilled artisan, the significant change to the interval 206A may represent a change in scene, a change in camera angle, a cutaway to a new image, a transition to black, etc. It therefore can be useful to establish those embedding vectors (202A, FIG. 7B) that correspond to the interval 206A as falling within a separate interval (segment) for classification purposes. It can be seen that the interval 206A is transitioned by significant changes in velocity at each end of the interval.

From a practical standpoint, the various frames corresponding to the vectors within the interval 206A may be a continuous scene with the same (or similar) visual elements, camera angle, lighting, etc. A change to these and other types of parameters, such as a cutaway to the face of a different speaker, may be detected as a separate interval. Nonetheless, the boundaries will depend upon the transitions among the movement vectors, which in turn will depend, at least in part, on the encoding used to define the embedding vectors. Each meaningful interval can be characterized as required and can be viewed as a clip, a scene, a segment, etc.

In another example, accelerated or peaking movement can be used to identify intervals of interest. FIG. 8B shows peaking movement in a significant interval 208A in a sequence of movement vectors 208. This may correspond, for example, to a climax in an action scene (e.g., a flash, an explosion, or some other short element of interest).

By observing direction as well as speed, further useful information about the importance of certain timestamp locations can be derived. In this way, the system can learn to ignore certain movements of the vector in a particular direction (for example, such as caused by camera movement in the movie), and to emphasize other movements in a different direction (for example, such as caused by a change in facial expression of a person).

While watching the speed and direction on the timebase of frames or groups of frames, the system may also take into consideration slow drifts in the latent space. This is carried out by comparing the positions in a longer time distance while the speed remains low to detect drifts over time, which might require a break in the time interval as there might be a new significant information. For example, a particular interval may involve a video depiction of the sky with a gradual transition from day to night. To do this, the system can be configured to first identify slow moving time intervals, and then observe the drift by observing the movement over a longer timeframe.

Based on these and other movement characteristics of the vectors in the sequence, further ANNs can be trained, allowing the efficient detection of these described time intervals, significant single data, and the prediction of the next data in an unfinished sequence, such as the next images while editing a movie. As noted above, derivatives and/or integrals of velocity and/or direction can be evaluated to further gain information or inputs into the ANNs on top of the embedding network.

It will be noted that the interval 208A in FIG. 8B has only a single vector (frame). In practice, each interval may have any number of related vectors (frames). In some alternative embodiments, multiple sets of intervals can be generated to provide different groupings based on different criteria to enhance the searching process for different input criteria. In this alternative approach, a pair of adjacent embedding vectors may appear in the same interval using a first characterization scheme, and the respective vectors may appear in two different adjacent intervals using a different second characterization scheme. The interval groupings under both schemes can be stored and subsequently searched to provide greater depth of coverage while focusing on different changes in content characteristics.

FIG. 9A is a simplified representation of a latent space 210 in which a group 212 of embedding vectors 214 has been arranged based on similarity measures and boundary detection evaluations such as described above in FIGS. 8A and 8B. It will be appreciated that the latent space 210 has only two dimensions (2D) for simplicity of illustration; in practice, many more dimensions will be in play. Moveover, while it is contemplated that each of the vectors 214 would likely tend to emerge from the same point of origin (e.g., the ends opposite the arrowheads would all begin from the same point), the vectors have been spread out so as to be adjacent one another in somewhat parallel fashion.

As can be seen from FIG. 9A, all of the embedding vectors 214 in the group 212 are somewhat similar, both in size and direction. In one approach, the processing system can operate to statistically calculate a representative vector (RV) 214A as a median vector, a mean vector, or some other vector that represents a statistical midline/vector for the group 212. The RV may be the closest vector to the middle of the group or may be a fictitious vector that represents the average of the group. Some other statistical characterization can be made as required. Regardless, the RV 214A represents the group of vectors for the associated interval.

FIG. 9B shows another simplified latent space 220 with a group 222 of embedding vectors 224. The group 222 in FIG. 9B is similar to the group 212 in FIG. 9A, although most of the member vectors have been omitted from FIG. 9B, the remaining vectors are shown in dotted line fashion. The RV is represented by heavy dotted line 224A, which is separated by angle theta to the closest vector in the group 224B. In this way, the RV can be represented by vector 224B plus the angle or in some other suitable statistical fashion.

In some cases the frames (digital elements) 200 from FIG. 7A can represent available footage yet to be assembled into a finished AV work or other digital data set. In this case, some of the various available frames can represent alternative available digital elements which can be organized for consideration in generating a final work. These can represent the same or similar shots or clips from different camera angles, different takes, different alternative footage segments, available for evaluation during a post-filming editing process. As explained below, in some cases specific AV works can be tailored in accordance with the preferences of different users, so that unique AV works are generated from different combinations of the various digital elements at different transition points along the sequence.

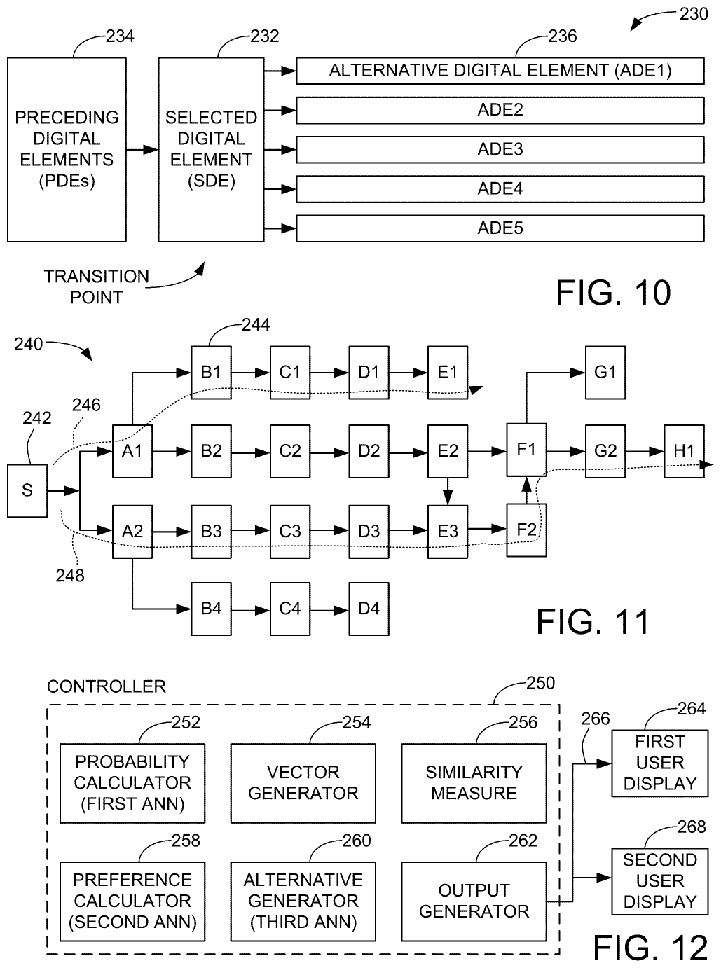

To this end, FIG. 10 shows a schematic representation of aspects of an AV work 230 under construction in accordance with some embodiments. It will be appreciated that the AV work will be stored in a tangible medium (such as computer memory) and arranged as a time-ordered sequence of digital elements to convey a human comprehensible narrative.

The elements include a selected digital element (SDE) 232 that is at a particular transition point in the time-ordered sequence, such as at the latest point in the assembled work. The transition point may be at some intermediate part of the work (as opposed to the very first), and is a point at which alternatives will be evaluated from this point forward. While not limiting, as noted previously the SDE 232 may be a single frame, a group of frames, a clip, a scene, etc.

In some cases, there may be some number of preceding digital elements (PDEs) 234 that precede the SDE 232 at the transition point. These may be the entirety of the work thus far, other works (e.g., episodes from previous seasons), a short time frame (e.g., the preceding X minutes) leading up to the transition point, etc. The digital content of the PDEs 234 will (hopefully) have a narrative content that naturally flows to and is consistent with that of the SDE 232.

In FIG. 10, there are five alternative digital elements 236 denoted as ADE1 through ADES. Some other number of alternative digital elements can be provided, so long as at least two alternatives are identified to generate at least two alternative time lines for consideration.

Each ADE 236 can represent a different aspect in the ongoing narrative, as discussed above (e.g., different plot direction, a different camera shot for similar plot elements, etc.). Regardless, the ADEs 236 each have a high probability of cohesiveness to the previous content of the prior elements 232, 234, and are selected based on probabilities as explained below. The ADEs can be different lengths and can be substantially similar to one another, or can be significantly different from one another (including opposite outcomes) to deviate the storyline in a significant way.

FIG. 11 is a tree diagram 240 for another work arranged in a manner similar to that of FIG. 10. In FIG. 11, a selected digital element(S) 242 has been selected as a particular transition point to evaluate various alternatives as represented by alternative elements 244 that branch as shown. Initially, there are only two (2) alternative elements A1 and A2 that have been selected for consideration as the follow-on content after element S, but these in turn branch out among various paths and layers having elements B1-B4, C1-C4, D1-D4, E1-E3, F1-F2, G1-G2 and H1.

It will be appreciated that other branching structures can be provided, with different numbers of layers, different numbers of alternative elements per layer, and so on. While each of these elements are the same size in the figure, it will be appreciated that this is a story board representation of the subsequent flow beyond the transition point at element S, so that the actual content may vary in a number of ways (frame count, duration, content, etc.) along each path. As noted above, the structure 240 in FIG. 11 can be depicted visually on a user display or other structure, although such is not required.

Conceptually, having selected two primary alternatives at A1 and A2 from transition point at element S, in this example a number of follow on time lines have been assembled to allow each alternative (and further alternatives) to be explored visually. One such timeline constitutes sequence S-A1-B1-C1-D1-E1, as denoted by dotted arrowed line 246. Another possible timeline constitutes the sequence S-A1-B2-C2-D2-E2-E3-F2-F1-G2-H1 (line 248), and so on. It can be seen that some paths can involve multiple alternatives in the same layer as with the timeline 248, or all alternatives can be mutually exclusive, as desired.

Regardless, at least two alternative time lines are generated downstream from the junction point S (e.g., commencing at A1 or A2) and from there, additional elements are selected to allow evaluation of how each of these alternative time lines play out with regard to overall cohesiveness. For example, alternative element A1 may initially appear to be a better choice than A2, but once further alternatives down the road are evaluated it may be that commencing with alternative A2 is the better choice for overall plot development and user satisfaction.

The length of each alternative time line can vary as required; in some cases, the alternatives will naturally terminate at a next junction point, which can then be further evaluated. In other cases, the alternative elements 244 in each subsequent layer can be selected based on probabilities up to some predefined value (scene length, elapsed time, plot climax point, etc.), after which the respective alternative timelines can be evaluated and compared. In some cases, each evaluated alternative timeline has in turn one or more alternatives, even if a particular optimum alternative is selected.

FIG. 12 is a functional block diagram for a controller circuit 250 that can be adapted to carry out the processing of FIGS. 10-11. While not limiting, in some embodiments the controller 250 constitutes one or more programmable processors that utilize corresponding memory for storage of data and programming instructions which are executed as required to carry out the various functions described herein.

In FIG. 12, the controller 250 includes a probability calculator circuit 252, which can be arranged as a first ANN that generates the various probabilities for the alternative digital elements (e.g., the ADEs 236 in FIG. 10 and the alternative elements A1 and A2 244 in FIG. 11). The output of the first ANN 252 may be a first set of scores in the form of probabilities based on training data supplied to the first ANN. In some embodiments, the PDEs 234 (FIG. 10) can be used to train the first ANN, which allows the ANN to naturally identify those alternatives that have the highest probabilities for cohesiveness. The first ANN 252 (and other ANNs) can take any suitable format, including a transformer, an LLM, an encoder/decoder network, etc.

A vector generator is represented at 254. This circuit can operate to generate a a probability embedding vector responsive to a set of probability scores associated with a selected ADE. This probability embedding vector, like the embedding vectors 202A, can be a multi-dimensional representation of the content of the selected ADE and can be compared, using a similarity measure block 256, with each of the representative vectors (214A, 224B) from segments (available digital elements) stored in memory. While cosine similarity is a particularly suitable comparison function, other similarity measurement techniques can be used to identify the ADEs.

A preference calculator circuit 258 may take the form of a second ANN which is trained using input data including historical preference data associated with a user. This can include real-time detected information using a sensor as described above, as well as history preference data accumulated over time. It is contemplated that the second ANN 258 will serve to provide a second set of probability scores that can be used to indicate whether a particular ADE will be subjectively preferred by a particular user. The user may be human or an A1 agent, and may be a composite of both.

An alternative generator 260 may take the form of a third ANN configured as a generative AI system. This can be useful as described above in situations where an available, existing digital element does not exist that satisfactorily describes a preferred alternative option, as determined by the first and/or second ANNs 252, 258.

An output generator 262 operates to use the scoring values obtained from the first and second ANNs to select an optimum timeline and assemble this into the AV work. In some embodiments, the assembled work is tailored to meet the preferences of a particular user, and the tailored work is transmitted for display on a user display 264 via a computer network 266.

In further embodiments, the user may be a first user for which the AV work is tailored, and a second user may receive a different output work using the other alternative timeline for display on a second user display 268. In this way, tailored output for different users can be generated using the same available digital elements with different alternative timelines suited to meet each user's particular preferences.

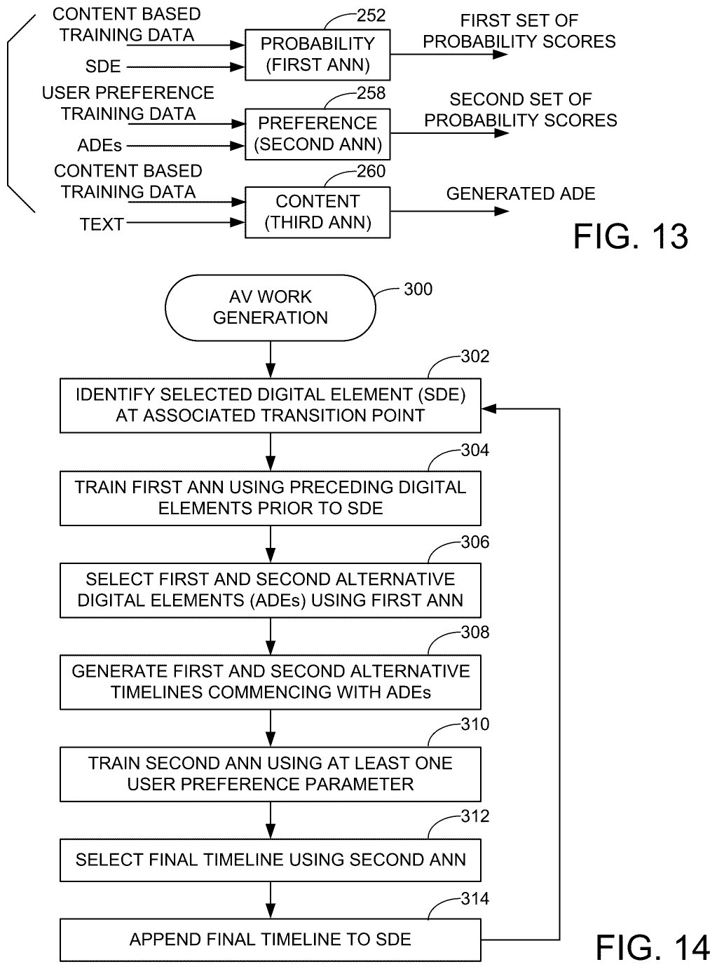

FIG. 13 shows a functional block diagram of the respective first, second and third ANNs 252, 258, 260 from FIG. 12 in some embodiments. The first ANN 252 generates a first set of probability scores after having been trained on content based training data (such as the PDEs 234, FIG. 10) and are used to identify the ADEs with the highest probability of suitability as alternatives after the junction point based on an input SDE.

The first ANN 252 can be configured to automatically factor in all of the various information regarding storyline continuity, timing, characters, and so on to generate the highest probability alternatives in a manner similar to an LLM can be used to identify the next token/phrase/sentence in an input grammatical structure. As such, any number of different types of ANN constructions can be used.

The second ANN 258 generates a second set of probability scores after having been trained on the user (human or AI) preference data, and provides the scores based on the various alternatives (ADEs) selected by the first ANN. As noted previously, the respective first and second ANNs will detect the “hidden rules” that govern the respective outputs and will find optimum solutions. These can be set to be adaptive over time based on prior work generation operations, so that consistently better performance results are obtained over time.

The third ANN 260 is likewise trained on content data, including the same input content data used to train the first ANN 252 or on other content data (including all of the available clips in storage). As discussed above, the third ANN 260 generates one or more of the AI-generated ADEs, which can be in lieu of or in addition to retrieved ADEs. A text based description, a vector, or some other input can be supplied to the third ANN to generate the output content.

FIG. 14 is a flow chart for an AV work generation routine 300 illustrative of steps carried out in accordance with some embodiments such as by the controller circuit 250 to generate an AV work (or some other type of digital data set as described herein). It will be appreciated that the routine 300 assembles the work as a sequence of digital elements each having at least a video (visual) component and optionally an audio component, such as but not limited to a feature length movie. The method may be executed by at least one programmable processor of the controller circuit using programming stored in an associated computer memory.

At step 302, the controller circuit proceeds to identify a selected digital element to be incorporated at a transition point in the time-ordered sequence. This can include, but is not limited to, the respective SDEs represented at 232, 242 discussed above in FIGS. 10-11.

At step 304, the controller circuit operates to select candidate alternative digital elements to immediately follow the selected digital element in the time-ordered sequence, such as but not limited to the five ADEs 236 in FIG. 10 and the two ADEs 244 B1-B2 in FIG. 11. It is contemplated that at least two ADEs will be identified, referred to herein as a first alternative digital element and a second alternative digital element, to provide at least two alternative possible sequencing timeline paths as described above.

A first ANN is trained at step 304 at least using a set of preceding digital elements (such as the PDEs 234, FIG. 10) that precede the transition point, as described in FIGS. 12-13. Thereafter, the first and second ADEs are selected at step 306 responsive to a first set of probability scores calculated by the first trained ANN. These may be selected from existing available digital elements in memory such as through the use of the vector generation and comparison capabilities of the controller 250 (blocks 254, 256), or via generation by the third ANN 260.

At least first and second alternative timelines are thereafter constructed commencing with and including the first and second ADEs, step 308. Examples include the alternative timelines 246, 248 in FIG. 11. Other timelines, including overlapping or separate timelines, can be constructed as required. The first and second alternative timelines include a plurality of successive digital elements that follow the respective first and second alternative digital element to respective conclusion points. These conclusion points may be dead ends (e.g., a sequence that ultimately is unworkable and is abandoned), a natural breaking point, or may be some predetermined length.

At step 310, at least one user preference parameter associated with a user is identified and used to train a second ANN, such as the ANN 258. This generates a second set of probability scores, which are used to select the final timeline as a selected one of the at least first or second alternative timelines responsive to the second set of probability scores, step 312.

In some cases, the probability scores used in step 312 may be generated by assigning a preference probability value associated with the user for each of the digital elements in each alternative timeline, and combining these to arrive at an overall preference probability value. Weight values may be included in this calculation as required. In this embodiment, the timeline with the higher value is selected as the final timeline.

Finally, as shown by step 314, the final timeline selected in step 312 is appended to the SDE. As required, the end of the appended timeline is used as the next transition point, and the routine 300 returns to block 302 for evaluation of the next set of alternatives.

The mechanisms presented in this disclosure enables creators to quickly and efficiently explore various audiovisual narrative timelines. The system accepts individual assets, existing timelines, story descriptions, etc. as input and provides a tool that leverages AI to assist users in exploring and rapidly evaluating these alternative timelines for further refinement in audiovisual editing software.

The system permits users to select a point within the sequence of elements-typically, but not exclusively, the last one—and offers assets, sourced from existing materials or generated by AI, that are viable and probable options to continue the timeline from that point. For instance, upon entering an old library in the timeline, the mechanism presents the user with different options for continuing the sequence. One possibility is to transition to a bookshelf and further to a close-up of a book; another is to depict individuals at a reading desk engrossed in books, and so on.

The AI presents the user/agent with various options at a specific point on the timeline, taking into account previous elements of the timeline as well as the title, description, script, mood images, drawings, or any additional information (such as for example the desired overall length of the sequence). With an understanding of world causality, aesthetics, and storytelling principles, it can predict the likely subsequent elements and present these to the user for selection. Once the user makes a decision (or an AI agent makes the selection in the user's interest), this process can be repeated until the narrative is complete or indefinitely, if desired. Beside a more typical tail-end approach, where new elements are added to the end of the sequence, users can select any point within an existing sequence to diverge and explore alternative timelines.

In some cases, multiple layers of AI agents can be used: one to present the various clips available for selection, one to make the actual selection, and one that monitors a viewer and provides feedback on upcoming selections. Each of these functions can be incorporated into a single module.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer-implemented method for generating an audio-visual (AV) work stored in a tangible medium and arranged as a time-ordered sequence of digital elements to convey a human comprehensible narrative, the method executed by at least one programmable processor using associated computer memory and comprising:
identifying a selected digital element to be incorporated at a transition point in the time-ordered sequence;
selecting, as candidates to immediately follow the selected digital element in the time-ordered sequence, a first alternative digital element and a second alternative digital element responsive to a first set of probability scores calculated at least in part upon a set of preceding digital elements that precede the transition point, the first set of probability scores generated responsive to a first artificial neural network (ANN) trained using the set of preceding digital elements;
generating a first alternative timeline comprising the first alternative digital element in combination with a first succession of digital elements that successively follow the first alternative digital element to a first conclusion point;
concurrently generating a second alternative timeline comprising the second alternative digital element in combination with a second succession of digital elements that successively follow the second alternative digital element with a second narrative outcome to an alternative, second conclusion point;
identifying at least one user preference parameter associated with a user;
determining a second set of probability scores using a second ANN trained using the at least one user preference parameter;
selecting a final timeline as a selected one of the first or second alternative timelines responsive to the second set of probability scores; and
incorporating the final timeline into the AV work immediately following the selected digital element.

2. The method of claim 1, further comprising a subsequent step of transmitting, via a computer network, the AV work having the incorporated final timeline for display on a display device to the user.

3. The method of claim 2, wherein the user is a first user, the AV work is a first AV work and the final timeline incorporated into the first AV work is the first alternative timeline, and wherein the method further comprises a subsequent step of transmitting, via a computer network, a second AV work that incorporates the second alternative timeline in lieu of the first alternative timeline to a second user.

4. The method of claim 1, further comprising generating a probability embedding vector responsive to the first set of probability scores, and comparing, using a similarity measure, the probability embedding vector to each of a plurality of representative embedding vectors associated with a plurality of available digital elements stored in the computer memory.

5. The method of claim 4, wherein the representative embedding vector of the first alternative digital element has a closest similarity measure to the probability embedding vector from among the plurality of representative embedding vectors.

6. The method of claim 1, wherein a selected one of the first or second alternative digital element is generated using a third ANN using a textual input generated responsive to the first set of probability scores.

7. The method of claim 1, wherein the first succession of digital elements in the first alternative timeline are generated by repeating the selecting, generating, concurrently generating, identifying and determining steps for each successive digital element in the first succession of digital elements in turn.

8. The method of claim 1, wherein the second set of probability scores combines a preference probability value associated with the user for each of the digital elements in the first alternative timeline to generate a first weighted preference probability value.

9. The method of claim 1, further comprising using a sensor that detects a facial response of the user to identify the at least one preference parameter of the user.

10. The method of claim 1, further comprising prior steps of using a filming process to accumulate a population of available digital elements and storing the available digital elements in the computer memory, and wherein the method comprises a post filming editing process in which the first and second timelines are generated from the population of available digital elements.

11. The method of claim 1, wherein the user is a human.

12. The method of claim 1, wherein the user is an AI agent.

13. A computer system configured to generate an audio-visual (AV) work stored in a tangible medium and arranged as a time-ordered sequence of digital elements to convey a human comprehensible narrative, each of the digital elements at least having an associated audio component or an associated visual component, the computer system comprising:
a computer memory which stores a plurality of digital sequences; and
a programmable processor having program instructions stored in the computer memory which, when executed, performs the following operations:
identifying a selected digital element to be incorporated at a transition point in the time-ordered sequence;
selecting, as candidates to immediately follow the selected digital element in the time-ordered sequence, a first alternative digital element and a second alternative digital element responsive to a first set of probability scores calculated at least in part upon a set of preceding digital elements that precede the transition point, the first set of probability scores generated responsive to a first artificial neural network (ANN) implemented in the computer memory and trained using the set of preceding digital elements;
generating a first alternative timeline comprising the first alternative digital element in combination with a first succession of digital elements that successively follow the first alternative digital element to a first conclusion point;
concurrently generating a second alternative timeline comprising the second alternative digital element in combination with a second succession of digital elements that successively follow the second alternative digital element with a second narrative outcome to an alternative, second conclusion point;
identifying at least one user preference parameter associated with a user;
determining a second set of probability scores using a second ANN implemented in the computer memory and trained using the at least one user preference parameter;
selecting a final timeline as a selected one of the first or second alternative timelines responsive to the second set of probability scores; and
incorporating the final timeline into the AV work immediately following the selected digital element.

14. The computer system of claim 13, wherein the programmable processor is further configured to transmit, via a computer network, the AV work having the incorporated final timeline for display on a display device to the user.

15. The computer system of claim 13, wherein the user is a first user, the AV work is a first AV work and the final timeline incorporated into the first AV work is the first alternative timeline, and the programmable processor is further configured to transmit, via a computer network, a second AV work that incorporates the second alternative timeline in lieu of the first alternative timeline to a second user.

16. The computer system of claim 13, wherein the programmable processor is further configured to generate a probability embedding vector responsive to the first set of probability scores, and comparing, using a similarity measure, the probability embedding vector to each of a plurality of representative embedding vectors associated with a plurality of available digital elements stored in the computer memory.

17. The computer system of claim 13, wherein the representative embedding vector of the first alternative digital element has a closest similarity measure to the probability embedding vector from among the plurality of representative embedding vectors.

18. The computer system of claim 13, wherein a selected one of the first or second alternative digital element is generated using a third ANN implemented in the computer memory and using a textual input generated responsive to the first set of probability scores.

19. The computer system of claim 13, wherein the programmable processor is further configured to generate each digital element in the first succession of digital elements in the first alternative timeline by repeating the selecting, generating, concurrently generating, identifying and determining operations in turn and selecting each digital element for inclusion in the first succession of digital elements having a highest probability score.

20. The method of claim 1, further comprising prior steps of using a filming process to accumulate a population of available digital elements and storing the available digital elements in the computer memory, and wherein the method comprises a post filming editing process in which the first and second timelines are generated from the population of available digital elements.
